(19) United States
(12) Patent Application Publication
(10) Pub. No.: US 2007/0013098 A1
(43) Pub. Date: Jan. 18, 2007

(54) Method for producing an si3n4 coated sio2 molded body

(75) Inventors: Fritz Schwertfeger, Burghausen (DE); Jens Günster, Clausthal-Zellerfeld (DE); Sven Engler, Clausthal-Zellerfeld (DE); Jürgen Heinrich, Clausthal-Zellerfeld (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 10/595,156

(22) PCT Filed: Sep. 2, 2004
(86) PCT No.: PCT/EP04/09792

§ 371 Date: Mar. 8, 2006

(30) Foreign Application Priority Data
Sep. 11, 2003 (DE) 103420428

(51) Int. Cl. H01S 3/00

(52) U.S. Cl. 264/131; 264/434; 264/482

(57) ABSTRACT

Silicone nitride coated shaped bodies of silica are prepared by coating a silica green body with silicon nitride or a precursor thereof, followed by sintering the silicone nitride coating by means of a laser beam. The shaped bodies are especially useful as “solar crucibles” in production of polycrystalline silicon for solar cells.

The invention relates to a process for producing an Si₃N₄-coated SiO₂ shaped body.

Porous, open-pore, amorphous SiO₂ shaped bodies are used in numerous technical fields. Examples which may be mentioned include filter materials, thermal insulation materials or heat shields. Furthermore, porous, open-pore, amorphous SiO₂ shaped bodies in rectangular form are used to crystallize silicon in the production of polycrystalline solar silicon ingots. These rectangular crucibles are referred to below as solar crucibles.

If liquid silicon is crystallized through slow cooling in the solar crucibles, it shrinks to a greater extent than the solar crucible made from SiO₂. Since the silicon is very securely joined to the inner side of the crucible, cracks occur in the polycrystalline silicon ingot. Since this must be avoided under all circumstances, all solar crucibles are provided on the inner side with a layer of Si₃N₄, which prevents the silicon from bonding to the crucible.

The porous, open-pore, amorphous solar crucibles are generally produced using a ceramic slip casting process. In this process SiO₂ particles are dispersed in water, are shaped, for example by means of a pressure die-casting process and are then dried and consolidated (partially sintered) by means of a heat treatment (sintering). In a second step, the Si₃N₄ layer is applied to the inner side. The prior art in this context is represented by the use of Si₃N₄ powder applied to the crucible surface using a plasma process, known as plasma spraying, where it forms the Si₃N₄ layer.

To maximize the efficiency of the solar silicon, it is extremely important for the high-purity silicon not to be contaminated with metals during the crystallization. Therefore, both the solar crucible and the Si₃N₄ layer have to be produced in as pure a form as possible.

In the methods for sintering the porous, open-pore, amorphous solar crucibles which are known from the prior art, such as, for example, furnace sintering, zone sintering, arc sintering, contact sintering, sintering with hot gases or by means of plasma, the solar crucibles that are to be sintered are heated by the transfer of thermal energy or thermal radiation. If the solar crucibles to be produced by this route are to have an extremely high purity with regard to any type of foreign atoms, the use of hot gases or hot contact surfaces leads to undesired contamination with foreign atoms.

If the Si₃N₄ layer is applied by means of a plasma process, thermal energy is likewise transferred by means of thermal radiation. In this case too, the use of hot gases leads to undesired contamination with foreign atoms.

Furthermore, the prior art has disclosed complex two-stage processes for producing Si₃N₄-coated solar crucibles.

It is an object of the present invention to provide a process for producing Si₃N₄-coated SiO₂ shaped bodies in which the risk of contamination to both the Si₃N₄ layer and the SiO₂ shaped body is reduced.

This object is achieved by a process in which a precursor which is suitable for forming an Si₃N₄ sintered layer is applied to the surface of an amorphous, open-pore SiO₂ green body, and then this surface of the SiO₂ green body is heated by contactless heating by means of a laser beam, in such a manner that the precursor is converted in situ into an Si₃N₄ sintered layer under a laser beam.

In principle, it is possible to use all types of lasers, but it is preferable to use a laser with a beam with a wavelength of 10.6 μm. In particular, all commercially available Co₂ lasers are suitable for use as the laser.

An SiO₂ green body is to be understood as meaning a porous, amorphous, open-pore shaped body produced from amorphous SiO₂ particles (silica glass) by shaping steps. The green body has preferably not yet been subjected to consolidation by means of a heat treatment.

SiO₂ green bodies are known from the prior art. Their production is described, for example, in patents EP 705797, EP 318100, EP 653381, DE-A 2218766, GB-B-2329893, JP 5294610, U.S. Pat. No. 4,929,579. SiO₂ green bodies, whose production is described in DE-A1-19943103, are particularly suitable.

All materials which, after heating, are able to form an Si₃N₄ sintered layer can be used as precursors for forming the Si₃N₄ layer. Examples of these materials include Si₃N₄ powder, silicon powder, silicon oxide/carbon mixtures or polysilazanes. If the shaped body according to the invention is a solar crucible, it is preferable for the precursor to be applied on one side, to the inner-side surface of the SiO₂ green body.

The preferred precursor is an Si₃N₄ powder. It is applied to the surface of the green body, dried if appropriate, and then forms an Si₃N₄ sintered layer as a result of the laser beam energy which is adsorbed.

All commercially available powders (for example those produced by H. C. Stark) can be used as the Si₃N₄ powder. Particularly fine-grained Si₃N₄ powders with a grain size of between 100 nm and 100 μm, are preferably used, particularly preferably those with a grain size of between 100 nm and 50 μm, and very particularly preferably those with a grain size of between 100 nm and 10 μm.

The Si₃N₄ powder can be applied to the surface of the SiO₂ green body using all methods known to the person skilled in the art. It is preferable for the surface to be sprayed with an Si₃N₄ powder dispersion. Suitable dispersants are in principle all solvents, and it is preferable to use alcohols, acetone and water, with water being particularly preferred. Furthermore, all additives which are known to the person skilled in the art, such as for example dispersants and liquefiers, can be used to improve the dispersion of the Si₃N₄ powder.

If the Si₃N₄ powder is applied as a dispersion, it is preferable for the layer to be dried after it has been applied. The drying is in this case carried out by means of methods known to the person skilled in the art, such as for example vacuum drying, drying by means of hot gases, such as for example nitrogen or air, or contact drying. A combination of the individual drying methods is also possible. Drying by means of hot gases is preferred.

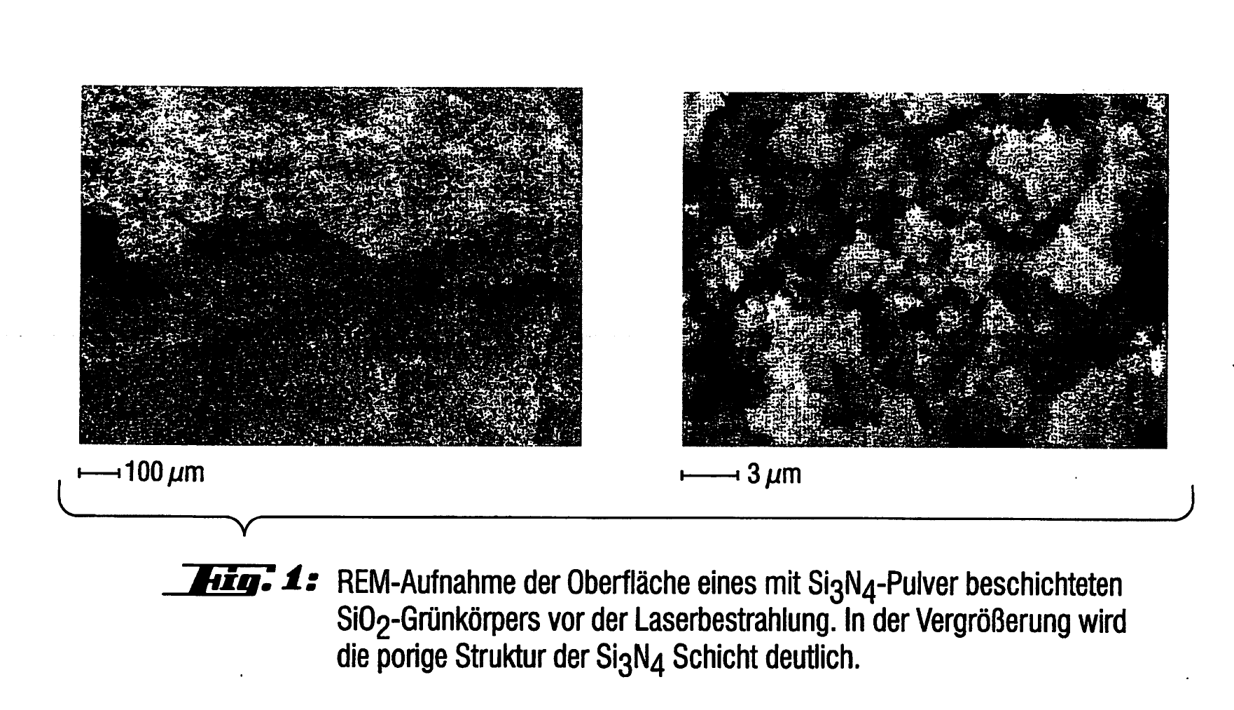

The Si₃N₄ powder layer obtained in this way generally has a layer thickness of from 1 to 1000 μm, preferably a layer thickness of from 1 to 500 μm and particularly preferably of from 1 to 100 μm. FIG. 1 shows a correspondingly coated surface.

To form the Si₃N₄ sintered layer and preferably to simultaneously consolidate the green body by partial sintering, the green body, after the precursor has been applied, is irradiated by a laser beam with a focal spot diameter of preferably at least 2 cm.

The irradiation is preferably carried out with a radiation power density of from 50 W to 500 W per square centimeter, particularly preferably from 100 to 200 and very particularly preferably from 130 to 180 W/cm². The power per cm² must be at least sufficient to form an Si₃N₄ sintered layer. The formation of the Si₃N₄ sintered layer preferably takes place at a temperature of between 1000° C. and 1600° C., particularly preferably between 1000° C. and 1200° C.

The irradiation is preferably carried out uniformly and continuously.

The uniform, continuous irradiation of the pretreated SiO₂ green body can in principle be carried out through a movable laser optic and/or a corresponding movement of the crucible in the laser beam.

The movement of the laser beam can be carried out using all the methods known to the person skilled in the art, for example by means of a beam-guidance system which allows the laser focus to move in all directions. The movement of the green body in the laser beam can likewise be carried out using all methods known to the person skilled in the art, for example by means of a robot. Furthermore, a combination of the two movements is possible.

In the case of relatively large shaped bodies, e.g. solar crucibles, scanning, i.e. a continuous, surface-covering displacement of the specimen beneath the laser focal spot, is preferred.

The formation of the Si₃N₄ sintered layer is controlled at all locations by the introduction of laser power.

It is preferable for the Si₃N₄ sintered layer to be formed as uniformly as possible. On account of the geometry of the SiO₂ green body, it may be the case that the laser beam does not always impinge on the green-body surface at a constant angle during the irradiation of the green body. Since the absorption of the laser radiation is angle-dependent, this results in an Si₃N₄ sintered layer of uneven thickness. A uniform Si₃N₄ sintered layer is obtained by virtue of the fact that the temperature in the focal spot of the laser can be measured at any time using a suitable means for measuring the temperature of the focal spot. Some of the reflected thermal radiation is transmitted via a special mirror system to a pyrometer which is used for temperature measurement.

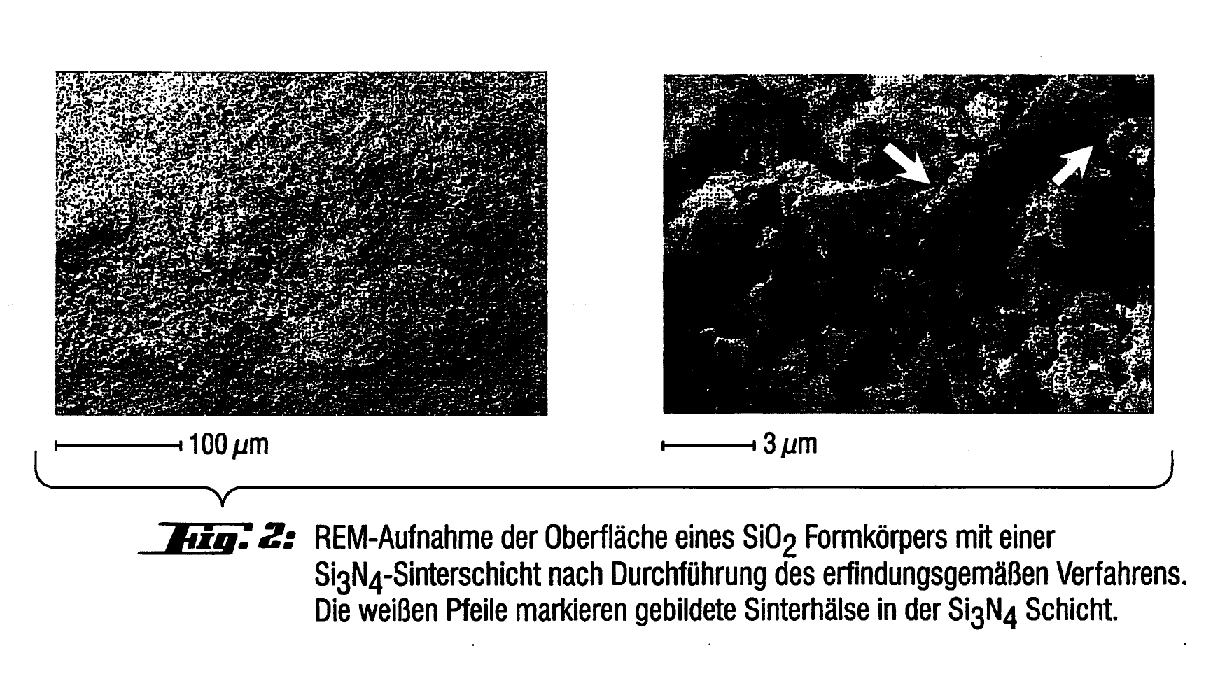

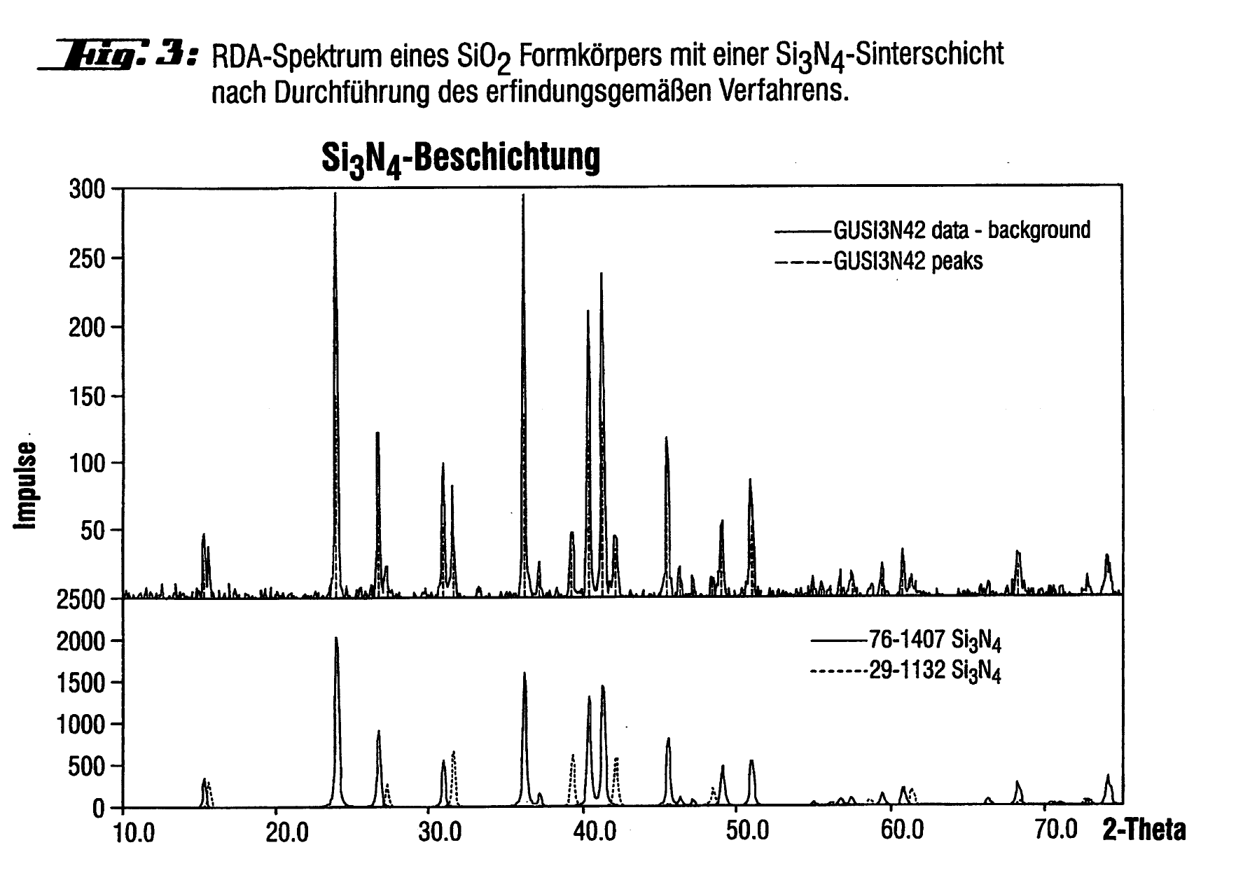

Incorporating this temperature measurement into the overall system of laser and moving green body furthermore allows one or more of the process variables laser power, displacement travel, displacement speed and laser focus to be adapted during the laser irradiation of the green body, in such a way that it is possible to produce a uniform Si₃N₄ sintered layer (FIGS. 2 and 3).

Furthermore, it is important in the process according to the invention that the SiO₂ green bodies have a porous structure, so that it is easy for precursors to infiltrate into the region of the green body close to the surface. This allows the formation of a silicon oxynitride interface between the SiO₂ body and the Si₃N₄ sintered layer.

The formation of the Si₃N₄ sintered layer may preferably be carried out under a reduced pressure or vacuum throughout the entire process.

If the process is carried out under a reduced pressure, the pressure is below standard pressure of 1013.25 mbar, and is particularly preferably between 0.01 and 100 mbar, very particularly preferably between 0.01 and 1 mbar. In a preferred embodiment, it is also possible to carry out the process in vacuo (<10⁻³ mbar), in order to produce layers which are completely free of bubbles.

The accurate residence time of the focal spot can be used to control not only the Si₃N₄ sintered layer but also the consolidation of the green body, through to complete vitrification.

This is realized by thermal conduction from the hot surface of the body into the shaped body at temperatures above 1000° C.

On account of the very low thermal conductivity of silica glass, the process according to the invention can be used to produce a very sharp, defined interface between consolidated and unconsolidated regions in the SiO₂ shaped body. This leads to SiO₂ shaped bodies with a defined sintering gradient.

Furthermore, the extreme temperature profile in the SiO₂ green body during the process suppresses crystallization of the silica glass.

Since in the case of inner-side consolidation of a green body in crucible form, there is no shrinkage of the crucible outer side, it is in this way easy to produce near net shape crucibles.

The partially-sintered, open-pore SiO₂ shaped body provided with an Si₃N₄sintered layer on the inner side is preferably a crucible for the crystallization of solar silicon.

FIG. 1 shows an SEM image of an SiO₂ green body coated with Si₃N₄ powder.

FIG. 2 shows an SEM image of an SiO₂ shaped body with an Si₃N₄ sintered layer after the process according to the invention has been carried out. Points at which the formation of sintered necks are visible are marked by arrows.

FIG. 3 shows the X-ray diffractometer spectrum (XRD) for an SiO₂ shaped body with an Si₃N₄ sintered layer after the process according to the invention has been carried out.

The invention is described in more detail below on the basis of examples.

### EXAMPLE 1

### Production of an Open-Pore, Porous, Amorphous SiO₂ Green Body in Crucible Form

Production was based on the process described in US-A-2003-0104920.

3800 g of double-distilled H₂O were introduced into a 10 liter plastic tub. First of all, 712 g of fumed silica, BET surface area 200 m²/g, obtainable under the trade name Wacker HDK® from Wacker Chemie GmbH. Munich, were stirred in over the course of 30 min using a plastic-coated propeller stirrer. Then, 8188 g of fused silica, mean particle size 15 μm, obtainable under the trade name Excelica® SE-15 from Tokuyama, were added in portions over the course of 30 min and dispersed.

Once dispersion was complete, the dispersion was subjected to a slight pressure reduction (0.8 bar) for 10 minutes in order to remove any included air bubbles.

The dispersion produced in this way consists of 8900 g of solid, corresponding to a solids content of 70% by weight (composed of 92% fused silica and 8% fumed silica).

The green body was produced by means of ceramic pressure die-casting. For this purpose, the SiO₂ dispersion from a storage container is forced under a pressure of 10 bar through a system of lines between two open-pore plastic membranes made from methyl methacrylate. The membranes have a porosity of 30% by volume and a mean pore radius of 20 μm. The distance between the two membranes allows the formation of a 10 mm thick body. The two membranes are subjected to a closure pressure of 200 bar.

The pressure acting on the dispersion forces the majority of the water in the dispersion into the membranes. The SiO₂ body is formed.

After the formation of the bodies, lasting 45 min, has ended, the pressure in the storage container is reduced to 0 bar above standard pressure. Special air and water lines laid in the membranes enable the shaped body formed to be acted on by air or water through the porous membranes for the purpose of final shaping. In the process, the shaped body is detached from the membrane.

The shaped body is detached firstly from the outer membrane and then from the inner membrane.

The amorphous, open-pore, porous shaped body produced in this way has a solids content of 89% by weight and a residual water content of 11% by weight. After drying for 3 hours at 90° C., the shaped body is completely dry.

### EXAMPLE 2

### Inner-Side Coating with Si₃N₄ Powder

172 g of Si₃N₄ powder (produced by H. C. Stark, D₅₀ value 4 μm) were dispersed in 50 g of double-distilled water with the aid of a plastic-coated propeller stirrer. This dispersion was sprayed uniformly onto the inner side of the crucible, with the aid of a commercially available paint gun, until a 100 μm thick layer had formed (cf. FIG. 1). This was followed by drying for one hour at 90° C. in a drying cabinet.

### EXAMPLE 3

### Formation of the Si₃N₄ Sintered Layer by Means of CO₂ Laser

The crucible was irradiated with a radiation power of 3 kW by means of an ABB robot (IRB 2400 model) under the focus of a CO₂ laser (TLF 3000 Turbo model).

The laser was equipped with a rigid beam guidance system and all the degrees of freedom of the movement were provided by the robot. In addition to a diverter mirror, which diverts the radiation emerging horizontally from the laser resonator into the vertical, the beam guidance was also equipped with optics for widening the primary beam. The primary beam had a diameter of 16 mm. After the parallel primary beam had passed through the widening optics, a divergent beam path resulted. The focal spot on the crucible had a diameter of 50 mm, with a distance of approx. 450 mm between optics and crucible. The robot was controlled using a program matched to the crucible geometry. With the crucible rotating (angular velocity 0.15°/s), first of all the laser covered the upper edge of the crucible over an angle range of 375°. Then, the remainder of the inner surface of the crucible was covered by the laser on a helical path. The rotational speed and advance rate of the crucible on an axis from the edge of the crucible toward the center were in this case accelerated in such a way that the area covered per unit time was constant. The irradiation was carried out at 150 W/cm².

In the same process step, in addition to the formation of an Si₃N₄ sintered layer on the surface of the green body, the SiO₂ shaped body was also partially sintered as a result of heat conduction from the hot inner surface into the interior of the shaped body. After the laser irradiation, the crucible is covered over its entire surface with a 100 μm thick, uniform, solid Si₃N₄ sintered layer yet retained its original external geometry. (cf. FIG. 2)

1-13. (canceled)

14. A process for producing an Si₃N₄-coated SiO₂ shaped body from an SiO₂ green body, wherein a precursor which is suitable for forming an Si₃N₄ sintered layer is applied to a surface of the amorphous, open-pore SiO₂ green body, and then the precursor is converted in situ into an Si₃N₄ sintered layer by irradiation with a laser beam.

15. The process of claim 14, wherein the laser beam is the beam from a CO₂ laser.

16. The process of claim 14, wherein the SiO₂ shaped body is a solar crucible, and the precursor is applied to the inner-side surface of the SiO₂ green body.

17. The process of claim 14, wherein the precursor which is suitable for forming an Si₃N₄ sintered layer is selected from the group consisting of Si₃N₄ powder, silicon powder, silicon oxide/carbon mixtures and polysilazanes.

18. The process of claim 17, wherein the precursor is an Si₃N₄ powder.

19. The process of claim 18, wherein the Si₃N₄ powder has a grain size of between 100 nm and 100 μm.

20. The process of claim 18, wherein the Si₃N₄ powder is applied in the form of an Si₃N₄ powder dispersion by spraying the surface of the SiO₂ green body, and is then dried.

21. The process of claim 20, wherein the dispersion contains a dispersant selected from the group consisting of alcohols, acetone and water.

22. The process of claim 19, wherein the Si₃N₄ powder layer has a layer thickness of from 1 to 1000 μm.

23. The process of claim 14, wherein the SiO₂ green body, after the precursor has been applied, is irradiated by a laser beam with a focal spot diameter of at least 2 cm.

24. The process of claim 14, wherein the laser beam has a radiation power density of from 50 W to 500 W per square centimeter.

25. The process of claim 14, wherein the formation of the Si₃N₄ sintered layer takes place at a temperature of between 1000° C. and 1600° C., particularly preferably between 1100° C.

26. The process of claim 14, wherein the irradiation is carried out uniformly and continuously.
